(19) United States
(12) Patent Application Publication
(10) Pub. No.: US 2014/0357424 A1
(43) Pub. Date: Dec. 4, 2014

(54) GOLF BALL WITH LOW DENSITY

(71) Applicant: NIKE, Inc., Beaverton, OR (US)

(72) Inventors: Hideyuki Ishii, Portland, OR (US); Arthur P. Molinari, Portland, OR (US); Thomas J. Kennedy, III, Wilbraham, MA (US)

(73) Assignee: NIKE, Inc., Beaverton, OR (US)

(21) Appl. No.: 14/270,845

(22) Filed: May 6, 2014

Related U.S. Application Data
(60) Provisional application No. 61/829,695, filed on May 31, 2013.

(51) Int. Cl. A63B 37/00; C08L 23/08; C08L 33/02; C08L 33/00

(52) U.S. Cl. CPC A63B 37/0082; C08L 33/00; C08L 23/08; C08L 33/02; A63B 37/008; A63B 37/0083; A63B 37/0054; A63B 37/0074; C08L 2205/025; C08L 2205/03; C08L 2207/04
USPC 473/377; 473/351; 264/250; 264/45.1

(57) ABSTRACT

A golf ball has a diameter of at least about 43.6 mm and a density of from about 0.85 g/cm³ to 1.05 g/cm³. The golf ball can be made of ionomer resin or a combination of ionomer resins, including highly neutralized polymers and highly resilient polymers as disclosed. The golf ball may have a solid core made of a highly neutralized polymer or highly resilient polymer and a cover of an ionomer resin.

### FIELD OF THE DISCLOSURE

The disclosed technology concerns golf balls made with thermoplastic materials and methods for making such golf balls.

### BACKGROUND

This section provides information helpful in understanding the disclosed technology but that is not necessarily prior art.

A golf ball's core and cover are constructed with polymer compositions including, for example, polybutadiene rubber, polyurethanes, polyamides, ionomers, and blends of such polymers. Ionomers, particularly ethylene-based ionomers, are a useful group of polymers for golf ball layers because of their toughness, durability, and wide range of hardness values.

Golf balls typically include a center or intermediate layer made of a thermoset rubber material. A rubber polymer like polybutadiene is compounded with a metal salt of an ethylenically unsaturated carboxylic acid, for instance zinc diacrylate, a free radical initiator, and a filler. Rubber cores and layers provide excellent ball properties but have a relatively high density. A golf ball that conforms to the rules established by the United States Golf Association (USGA) has a diameter of at least 42.672 mm and does not weigh more than 45.926 grams. Including denser materials like a rubber layer limits the volume (and thus the diameter) of a golf ball that conforms to USGA rules.

A larger diameter ball can be beneficial for a player who tends to connect with the ball of typical diameter above its equator. However, such a skilled player may not want to sacrifice distance due to the higher aerodynamic drag coefficient and lower resilience that comes with a larger diameter golf ball. Therefore, a need remains for a large diameter ball with good performance characteristics.

### SUMMARY OF THE DISCLOSURE

This section provides a general summary of the disclosure and is not comprehensive of its full scope or all of the disclosed features.

Disclosed is a golf ball with a diameter of at least about 43.18 mm and a density of up to 1.05 g/cm³. The density can be from about 0.85 g/cm³ up to 1.05 g/cm³. The diameter can be from about 43.6 mm up to about 46 mm. Golf ball diameter is measured from a fret of a dimple (that is, on a plateau area between dimples) to an opposite fret. Density of the ball is calculated by dividing the ball weight in grams by its volume calculated from its radius (( 4/3)πr³) in cubic centimeters (without correction for dimples). The disclosed golf ball offers advantages in putting and for players who tend to connect with the ball of typical diameter above its equator. The disclosed golf ball is also advantageous for player who have a lower head speed swing, particularly when the disclosed golf ball made with a highly neutralized polymer or a highly resilient polymer. A “highly neutralized polymer” is a composition including (a) a copolymer of (i) an alpha-olefin, (ii) a C₃ to C₈ α,β-ethylenically unsaturated carboxylic acid, and (iii) an ester comonomer and (b) a monomeric saturated or unsaturated acid with about 4 to 36 carbon atoms, where the composition is neutralized at least about 70% using at least one metal cation. A “highly resilient polymer” is a composition including (a) a copolymer of ethylene and at least one of acrylic acid and methacrylic acid, the copolymer having from about 5 to about 14 percent by weight of the acid monomer; (b) a metallocene-catalyzed copolymer of ethylene and octene; (c) an unsaturated fatty acid; and (d) a metal cation in an amount sufficient to neutralize from about 65 to about 90% of the acid groups in composition.

In various embodiments, the golf ball has a diameter of at least about 43.6 mm. For example, the golf ball can have a density of from about 0.85 g/cm³ to about 1.00 g/cm³. The golf ball can be made with from about 23 percent by volume to 100 percent by volume of at least one ionomer resin neutralized at least about 40%.

In various embodiments, the golf ball includes from about 23 percent by volume to 100 percent by volume of an ionomer resin neutralized at least about 40%. The golf ball may have a cover, a core, and optionally one or more intermediate layers between the cover and the core, and any of the cover, the core, and the intermediate layers (if present) may include an ionomer resin.

In various embodiments, the golf ball has a core and a cover, and the density of the golf ball without the cover is up to about 0.95 g/cm³. The polymeric portion of the cover can comprise at least one ionomer resin neutralized from about 40% to 100%. The polymeric portion of the cover can consist essentially of the at least one ionomer resin.

In various embodiments, the golf ball is solid; that is, it is not foamed and does not include any foamed layer. In other embodiments, the golf ball includes foamed material as a foamed layer or a foamed component in a layer. For example, a golf ball having a foamed core (two-piece ball having a cover and a core) or one or more of a foamed core or intermediate layer (three- or higher-piece ball having a cover, a core, and one or more intermediate layers between the core and the cover) of a foamed composition comprising a highly neutralized polymer or a highly resilient polymer has a density of from about 0.85 g/cm³ to about 1.05 g/cm³ and a diameter of at least 43.18 mm, for example a diameter of from 43.18 mm to about 46.3 mm and conforms to USGA rules. The golf ball can conform to the USGA IV test (not more than 255 feet per second). For example, such a golf ball can be made with the core comprising a combination of (i) a copolymer of an alpha olefin, from about 4 wt. % to about 35 wt. % of an ethylenically unsaturated acid, and, optionally, a softening monomer; (ii) an aliphatic, monomeric, mono-functional organic acid, and (iii) a sufficient amount of a metal cation to neutralize at least about 80% of the combined acid groups of (i) and (ii). The alpha olefin can be ethylene. The component (ii) can have from about 6 to about 36 carbon atoms. The golf ball can conform to the USGA IV test (not more than 255 feet per second). The alpha olefin can be ethylene and the component (ii) can have from about 6 to less than 36 carbon atoms. The metal cation (iii) can neutralize at least about 95% of the combined acid groups of (i) and (ii). In these and other embodiments, the cover can comprise at least one ionomer resin neutralized at least about 40%. For example, when the core is made of an ionomer resin such as the highly neutralized polymer made with components (i), (ii), and (iii) just described, the total amount of ionomer resin can be from about 50 percent by volume to 100% of the polymeric portion of the golf ball. When the cover is also made of an ionomer resin, the polymeric portion of the golf ball may consist essentially of ionomer resin.

In various embodiments, the golf ball is free of a thermoset polybutadiene rubber intermediate layer or core. The ball may be solid or may include a foamed layer. The golf ball may be free of any filler.

The golf ball can have a cover and a thermoplastic core. The thermoplastic core can be solid. In various embodiments, each of the cover, the core, and any intermediate layers present in the golf ball is thermoplastic.

Further disclosed in a golf ball having a density of 43.6 mm up to about 46 mm and a density of from about 0.85 g/cm³ to about 1.00 g/cm³. The core of the golf ball can be formed of a combination of (i) a copolymer of an alpha olefin, from about 4 wt. % to about 35 wt. % of an ethylenically unsaturated acid, and, optionally, a softening monomer; (ii) an aliphatic, monomeric, mono-functional organic acid, and (iii) a sufficient amount of a metal cation to neutralize at least about 80% of the combined acid groups of (i) and (ii). The alpha olefin can be ethylene. The aliphatic, monomeric, mono-functional organic acid (ii) can at least about 95% of the combined acid groups of (i) and (ii). The golf ball can have a cover comprising at least one ionomer resin neutralized at least about 40% with metal cations. The total amount of ionomer resin is at least about 50 percent by volume of the golf ball. In various embodiments, the polymeric portion of the golf ball consists essentially of ionomer resin (counting the component (ii) as part of the ionomer resin). In all of these examples, the ionomer resin may further comprise a metallocene-catalyzed block copolymer of ethylene and an α-olefin having 4 to about 8 carbon atoms. For example, the golf ball may have a diameter 43.18 mm to about 46.3 mm and conform to USGA rules. The golf ball can conform to the USGA IV test (not more than 255 feet per second).

Also disclosed is a golf ball comprising a layer of a foamed composition including (i) a copolymer of an alpha olefin, from about 4 wt. % to about 35 wt. % of an ethylenically unsaturated acid, and, optionally, a softening monomer; (ii) an aliphatic, monomeric, mono-functional organic acid, and (iii) a sufficient amount of a metal cation to neutralize at least about 70% of the combined acid groups of (i) and (ii). The golf ball with this layer has a diameter of at least about 43.18 mm and a density of from about 0.85 g/cm³ to about 1.05 g/cm³. For example, the diameter can be 43.18 mm to about 46.3 mm. The golf ball can be a conforming golf ball, i.e., the golf ball conforms to USGA rules. In various embodiments, the foamed composition can further include a metallocene-catalyzed block copolymer of ethylene and an α-olefin having 4 to about 8 carbon atoms. The cover can be made of an ionomer resin.

Further disclosed are methods of making a golf ball. Any of the disclosed golf ball embodiments can be made by the method. A method of making a golf ball is disclosed that includes forming a core; optionally, surrounding the core with one or more intermediate layers, and forming a cover as an outermost layer, wherein the golf ball has a diameter of about 43.6 mm up to about 46 mm and a density of from about 0.85 g/cm³ to 1.05 g/cm³. The core can be made of a member selected from the group consisting of a member selected from the group consisting of (i) copolymers of an alpha olefin, from about 4 wt. % to about 35 wt. % of an ethylenically unsaturated acid, and, optionally, a softening monomer neutralized at least about 40%, (ii) highly neutralized polymers, (iii) highly resilient polymers, (iv) combinations of (i)-(iii), (v) combinations of (i)-(iii) with uncrosslinked EPDM, and (vi) dynamically vulcanized EPDM in (i)-(iv). The core may consist essentially of the member. In addition or alternatively, the golf ball can be made with an intermediate layer of a member selected from the group consisting of (i) copolymers of an alpha olefin, from about 4 wt. % to about 35 wt. % of an ethylenically unsaturated acid, and, optionally, a softening monomer neutralized at least about 40%, (ii) highly neutralized polymers, (iii) highly resilient polymers, (iv) combinations of (i)-(iii), (v) combinations of (i)-(iii) with uncrosslinked EPDM, and (vi) dynamically vulcanized EPDM in (i)-(iv). The intermediate layer may consist essentially of the member. In each case, the member may be foamed. The cover may be formed of ionomer resin. The golf ball may be made using only solid layers or may be made with a foamed layer. The golf ball may be made with only thermoplastic polymers.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiment. For convenience, “polymer” and “resin” are used interchangeably to encompass resins, oligomers, and polymers. The terms “comprises,” “comprising,” “including,” and “having,” are inclusive and therefore specify the presence of stated items, but do not preclude the presence of other items. As used in this specification, the term “or” includes any and all combinations of one or more of the listed items. When the terms first, second, third, etc. are used to differentiate various items from each other, these designations are merely for convenience and do not limit the items.

### DETAILED DESCRIPTION

A detailed description of exemplary, nonlimiting embodiments follows.

A golf ball is disclosed that has a diameter of at least about 43.6 mm and a density of from about 0.85 g/cm³ to not more than 1.05 g/cm³. In various embodiments, the golf ball may have a diameter of at least about 44.0 mm, or the golf ball may have a diameter of at least about 44.2 mm, or the golf ball may have a diameter of or at least about 44.5 mm. In certain embodiments, the golf ball diameter is from about 43.6 mm or from about 43.8 mm, or the golf ball diameter is from about 44.0 mm or from about 44.2 mm or from about 44.5 mm up to about 45 mm or up to about 45.5 mm or up to about 46 mm or up to about 46.3 mm. In a first example the golf ball diameter is from about 43.6 mm up to about 46.3 mm, and in a second example the golf ball diameter is from about 43.8 mm up to about 46. mm, and in a third example the golf ball diameter is from about 44.0 mm up to about 45.5 mm, and in a fourth example the golf ball diameter is from about 44.2 mm up to about 45 mm. In addition, the density may be from about 0.95 g/cm³ to 1.05 g/cm³ or from about 0.95 g/cm³ to about 1.02 g/cm³ or from about 0.95 g/cm³ to about 1.00 g/cm³ or from about 0.95 g/cm³ to about 0.98 g/cm³. Nonlimiting examples of combinations of these ranges include golf balls having a diameter of from about 44 mm to about 46.3 mm or from about 44.2 mm to about 46.3 mm and a density of from about 0.95 g/cm³ to about 1.00 g/cm³ or a density of from about 0.95 g/cm³ to about 0.98 g/cm³.

The golf ball may be a single-piece ball, a two-piece ball having a core and a cover, or a multi-piece ball have a core, a cover, and one or more intermediate layers between the core and the cover. The golf ball may be fully thermoplastic and can be free of a thermoset rubber core or any thermoset rubber intermediate layer. In various embodiments, the golf ball is solid. In other embodiments, the golf ball may include foamed material as a foamed layer or a foamed component in a layer. The layer may be made of the same materials described for solid layers, but which is foamed according to known method, for example by including physical or chemical blowing agent during molding. A foamed component, such as a polymer bead foam or comminuted foamed ceramic material, may be included in a layer.

The golf ball includes at least one thermoplastic elastomer and may also include one or more non-elastomeric thermoplastic polymers. Nonlimiting examples of suitable thermoplastic elastomers that can be used in making the golf ball include metal cation ionomers of addition copolymers (“ionomer resins,” including highly neutralized polymers and highly resilient polymers), metallocene-catalyzed block copolymers of ethylene and α-olefins having 4 to about 8 carbon atoms, thermoplastic polyamide elastomers (PEBA or polyether block polyamides), thermoplastic polyester elastomers, thermoplastic styrene block copolymer elastomers such as poly(styrene-butadiene-styrene), poly(styrene-ethylene-co-butylene-styrene), and poly(styrene-isoprene-styrene), thermoplastic polyurethane elastomers, thermoplastic polyurea elastomers, dynamic vulcanizates of rubbers, such as polybutadiene and EPDM, in these thermoplastic elastomers and in other thermoplastic matrix polymers, and uncrosslinked EPDM. These materials may be used in combination one of the core, the cover, or an intermediate layer (if present) of the golf ball.

In various embodiments, the golf ball includes an ionomer resin or a combination of ionomer resins. Ionomer resins are metal cation ionomers of addition copolymers of ethylenically unsaturated acids. Suitable examples of useful ionomers are copolymers of at least one alpha-olefin, at least one C₃₋₈ α,β-ethylenically unsaturated carboxylic acid, and optionally one or more other comonomers. The copolymers may contain as a comonomer at least one softening monomer such as an ethylenically unsaturated ester, for example vinyl acetate or an alkyl acrylate or methacrylate such as a C₁ to C₈ alkyl acrylate or methacrylate ester. The at least one alpha-olefin may be or include ethylene.

The weight percentage of acid monomer units in the ionomer copolymer may be in a range having a lower limit of about 1 or about 4 or about 6 or about 8 or about 10 or about 12 or about 15 or about 20 weight percent and an upper limit of about 20 (when the lower limit is not 20) or about 25 or about 30 or about 35 or about 40 weight percent based on the total weight of the acid copolymer. The weight percentage of acid monomer units in the ionomer copolymer can be from about 4 weight percent or about 6 weight percent or about 8 weight percent up to about 20 weight percent or up to about 25 weight percent or up to about 35 weight percent of the copolymer. The α,β-ethylenically unsaturated acid may, for example, be selected from acrylic acid, methacrylic acid, ethacrylic acid, maleic acid, crotonic acid, fumaric acid, itaconic acid, and combinations of these. In various embodiments, acrylic acid and methacrylic acid may be used.

The acid monomer is copolymerized with an alpha-olefin, for example selected from ethylene and propylene. The weight percentage of alpha-olefin units in the ionomer copolymer may be up to the balance of the ionomer copolymer that is not acid monomer units, depending on whether a comonomer is included, and may be from at least about 15 weight percent up to about 96 weight percent of the ionomer copolymer.

In certain embodiments, the ionomer copolymer includes no other comonomer besides the alpha-olefin and the ethylenically unsaturated carboxylic acid. In other embodiments, at least one softening comonomer is copolymerized. Nonlimiting examples of suitable softening comonomers are alkyl esters of C₃₋₈ α,β-ethylenically unsaturated carboxylic acids, particularly those in which the alkyl group has 1 to 8 carbon atoms, for instance methyl acrylate, methyl methacrylate, ethyl acrylate, ethyl methacrylate, propyl acrylate, propyl methacrylate, butyl acrylate, butyl methacrylate, isobutyl acrylate, tert-butyl methacrylate, hexyl acrylate, 2-ethylhexyl methacrylate, and combinations of these. When the ionomer includes a softening comonomer, the softening comonomer monomer units may be present in a weight percentage of the copolymer in a range with a lower limit of a finite amount more than zero, or about 1 or about 3 or about 5 or about 11 or about 15 or about 20 weight percent of the copolymer and an upper limit of about 23 or about 25 or about 30 or about 35 or about 50 weight percent of the copolymer.

Nonlimiting specific examples of acid-containing ethylene copolymers include copolymers of ethylene/acrylic acid/n-butyl acrylate, ethylene/acrylic acid/methyl acrylate, ethylene/methacrylic acid/n-butyl acrylate, ethylene/methacrylic acid/isobutyl acrylate, ethylene/acrylic acid/isobutyl acrylate, ethylene/methacrylic acid/n-butyl methacrylate, ethylene/acrylic acid/methyl methacrylate, ethylene/acrylic acid/methyl acrylate, ethylene/methacrylic acid/methyl acrylate, ethylene/methacrylic acid/methyl methacrylate, and ethylene/acrylic acid/n-butyl methacrylate. Among useful acid-containing ethylene copolymers are copolymers of ethylene/methacrylic acid/n-butyl acrylate, ethylene/acrylic acid/n-butyl acrylate, ethylene/methacrylic acid/methyl acrylate, ethylene/acrylic acid/ethyl acrylate, ethylene/methacrylic acid/ethyl acrylate, and ethylene/acrylic acid/methyl acrylate. For example, acid-containing ethylene copolymers such as ethylene/(meth)acrylic acid/n-butyl acrylate, ethylene/(meth)acrylic acid/ethyl acrylate, and ethylene/(meth)acrylic acid/methyl acrylate copolymers can be used.

The acid moiety in the ethylene acid copolymer is neutralized by any metal cation. Suitable metal salts may include Group I alkali metal salts, Group II alkaline earth metal salts, and transition metal salts. For example, lithium, sodium, potassium, magnesium, calcium, iron, barium, lead, tin, zinc, aluminum, bismuth, chromium, cobalt, copper, strontium, titanium, tungsten, nickel, manganese, or a combination of these cations may be used. In particular examples, alkali, alkaline earth, or zinc metal cations may be used.

Nonlimiting examples of suitable sources for the metal cation that may be used in the highly resilient polymer include acetates, oxides and hydroxides of lithium, calcium, zinc, sodium, potassium, nickel, magnesium, aluminum, zirconium and manganese. Some specific, nonlimiting examples of suitable metal cation sources are lithium hydroxide monohydrate, lithium hydroxide, lithium oxide, lithium acetate, calcium hydroxide, calcium acetate, calcium oxide, zinc acetate dihydrate, zinc acetate or a blend of zinc oxide and acetic acid, sodium hydroxide, sodium acetate, potassium hydroxide, potassium acetate, nickel acetate, nickel oxide, nickel hydroxide, magnesium oxide, magnesium hydroxide, magnesium acetate, manganese acetate, and manganese oxide. These may be used in any combination.

An ionomer resin can be formed by adding a sufficiently high molecular weight, monomeric, mono-functional organic acid or salt of organic acid to the acid copolymer or ionomer so that the acid copolymer or ionomer can be neutralized, without losing processability, to a level above the level that would cause the ionomer alone to become non-melt-processable, such as at least 70% of the total acid groups in the ionomer resin-mono-functional organic acid or salt composition (a “highly neutralized polymer”). The monomeric, mono-functional organic acid its salt may be added to the ethylene-unsaturated acid copolymers before they are neutralized or after they are optionally partially neutralized to a level between about 1 and about 100%, provided that the level of neutralization is such that the resulting ionomer remains melt-processable. In generally, when the monomeric, mono-functional organic acid is included the acid groups of the copolymer may be neutralized from at least about 40%, or at least about 70%, or at least about 80% or at least about 90%, or at least about 95%, or about 100% and up to 100% without losing processability. Such high neutralization, particularly to levels of at least about 70% or at least about 80% or at least about 90% or at least about 95% or at least about 100% up to fully neutralized, without loss of processability can be done by (a) melt-blending the ethylene α,β-ethylenically unsaturated carboxylic acid copolymer or a melt-processable salt of the copolymer with the organic acid or the salt of the organic acid, and (b) adding a sufficient amount of a cation source up to 110% of the amount needed to neutralize the total acid in the copolymer or ionomer and organic acid or salt to the desired level to increase the level of neutralization of all the acid moieties in the mixture at least about 70% or at least about 80%, at least about 90%, at least about 95%, and up to about 100%. To obtain 100% neutralization, one can add a slight excess of up to 110% of cation source over the amount stoichiometrically required to obtain the 100% neutralization.

Examples of monomeric, monofunctional organic acids are aliphatic or aromatic saturated or unsaturated acids that may have from 6 or about 8 or about 12 or about 18 carbon atoms to about 36 carbon atoms or less than 36 carbon atoms. Nonlimiting suitable examples of the monomeric, monofunctional organic acid includes caproic acid, caprylic acid, capric acid, lauric acid, stearic acid, behenic acid, erucic acid, oleic acid, linoleic acid, myristic acid, benzoic acid, palmitic acid, phenylacetic acid, naphthalenoic acid, dimerized derivatives of these, and their salts, particularly the barium, lithium, sodium, zinc, bismuth, chromium, cobalt, copper, potassium, strontium, titanium, tungsten, magnesium or calcium salts. These may be used in any combination.

Many grades of ionomer resins are commercially available, for example from E.I. du Pont de Nemours and Company, Inc. under the trademark Surlyn® or the designation “HPF,” from ExxonMobil Chemical under the trademarks Iotek™ and Escor™, or from Honeywell International Inc. under the trademark AClyn®. The various grades may be used in combination.

In various embodiments, the golf ball includes from about 23 percent by volume to 100 percent by volume of at least one ionomer resin neutralized at least about 40%. In particular, the total amount of ionomer resin or highly neutralized polymer may be at least about 50 percent by volume of the golf ball.

The golf ball may include only, or essentially only, one or more ionomer resins. In such cases, the ionomer resin or resins may be at least about 90 weight percent, or at least about 95 weight percent, or at least about 97 weight percent or at least about 98 weight percent or at least about 99 weight percent, or about 100 weight percent up to all of the polymeric portion of the golf ball. In various example embodiments, the ball may have a core of highly neutralized polymer of the acrylic or methacrylic acid type, such as DuPont™ HPF 2000 or AD-1035 made by E.I. du Pont de Nemours and Company, Inc. One or more antioxidants may be added, for example Irganox® 1010 made by BASF Corporation. The ball may have an ionomer cover of one ionomer or of a combination of ionomers, which may be pigmented, for example with rutile titanium dioxide.

In various example embodiments, the golf ball includes a highly resilient polymer. The highly resilient polymer may be prepared by mixing and reacting a combination including (a) an unneutralized (non-ionomeric) copolymer of ethylene and at least one of acrylic acid and methacrylic acid, which has from about 5 to about 14 percent by weight of the acid monomer; (b) a metallocene-catalyzed copolymer of ethylene and octene; (c) a monomeric, mono-functional organic acid as already described; and (d) a metal cation in an amount sufficient to neutralize from about 65 to about 90% of the acid groups in the combination to produce a neutralized ionomer material. The components may be mixed at a temperature above the glass transition or melting point temperatures of both copolymers.

The unneutralized (non-ionomeric) copolymer of ethylene and at least one of acrylic acid and methacrylic acid has from about 5 to about 14 percent by weight of the acid monomer. In various embodiments, this copolymer has from about 6 or from about 7 or from about 8 or from about 9 percent by weight up to about 10 or up to about 11 or up to about 12 or up to about 14 percent by weight of the acid comonomer. Particular examples that may be mentioned are copolymers of ethylene and acrylic acid that have from about 6 to about 11 percent by weight of the acrylic acid monomer or from about 7 to about 11 percent by weight of the acrylic acid monomer or from about 8 to about 10.5 percent by weight of the acrylic acid monomer and copolymers of ethylene and methacrylic acid that have from about 8 to about 14 percent by weight of the methacrylic acid monomer or from about 9 to about 14 percent by weight of the methacrylic acid monomer. In certain embodiments the copolymer of ethylene and at least one of acrylic acid and methacrylic acid has a melt index of from about 7 to about 25 g/10 min. (2.16 kg @ 190° C.) as measured according to ASTM D 1238.

Examples of suitable non-ionic (unneutralized) ethylene/acrylic acid or ethylene/methacrylic acid copolymers that are commercially available include Primacor 3440, an ethylene/acrylic acid copolymer having 9.7 wt % acrylic acid comonomer, a melt index of 10 g/10 min. (2.16 kg @ 190° C. according to ASTM D 1238), a density of 0.932 g/cm³, a DSC melting peak at 98° C., and a Vicat softening point of 81° C. (ASTM D 1525), and Primacor 3460, both available from Dow Chemical Company, Midland, Mich.; ethylene methacrylic acid materials under the tradename of Nucrel, available from DuPont; and ethylene acrylic acid copolymers sold under the tradename Escor available from ExxonMobil.

The metallocene-catalyzed copolymer (b) of ethylene and octene can be prepared using metallocene single-site catalysis. Example copolymers may contain from about 10 to about 50% by weight of octene monomer units. The copolymers of ethylene and octene included in a thermoplastic material may be formed by single-site metallocene catalysis such as disclosed in EP 0029358, U.S. Pat. Nos. 4,752,597, 4,808,561, and 4,937,299, the teachings of which are incorporated herein by reference. Such copolymers can be produced by, for example, a high pressure polymerization process in the presence of a catalyst system comprising a cyclopentadienyl-transition metal compound and an alumoxane. These copolymers may also be produced as disclosed in U.S. Pat. No. 5,272,236, the teachings of which are incorporated herein by reference. For example, embodiments the copolymer of ethylene and octene has a melt index of from about 0.5 to about 30 g/10 min. (2.16 kg @ 190° C.) as measured according to ASTM D 1238.

Nonlimiting examples of suitable commercial copolymers of ethylene and 1-octene include those sold by ExxonMobil under the trade name Exact™ and by the Dow Chemical Company under the trade name Engage™ 8200, Engage™ 8207, Engage™ 8130, and Engage™ 8137. Such copolymers are substantially linear polymers having a density of about 0.86 g/cc to about 0.87 g/cc as measured in accordance with ASTM D-792, a melt index (MI) of about 0.5 to about 30 g/10 minutes (2.16 kg @ 190° C.) as measured according to ASTM D 1238, and may have a Shore D hardness of between 70 and 54.

The unneutralized or non-ionic copolymer (a) of ethylene and at least one of acrylic acid and methacrylic acid may be from about 10 to about 90 weight percent of the combined weights of the unneutralized or non-ionic copolymer (a) of ethylene and at least one of acrylic acid and methacrylic acid and the metallocene-catalyzed copolymer (b) of ethylene and octene. In various embodiments, the unneutralized or non-ionic copolymer (a) of ethylene and at least one of acrylic acid and methacrylic acid may be from about 25 to about 75 weight percent of the combined weights of the unneutralized or non-ionic copolymer (a) of ethylene and at least one of acrylic acid and methacrylic acid and the metallocene-catalyzed copolymer (b) of ethylene and octene.

Specific examples of suitable monomeric, mono-functional organic acids include, without limitation, any of those already mentioned above, such as caprylic acid, capric acid, lauric acid, myristic acid, palmitic acid, stearic acid, behenic acid, and ceotic acid. Combinations of these may be used. In general, the saturated fatty acids may be used in the amount of 50 to 175 parts by weight based on 100 parts by weight of the ethylene and acid copolymer.

A metal cation (d) is added to the mixture of copolymer (a) of ethylene and at least one of acrylic acid and methacrylic acid, the copolymer (b) of ethylene and octene, and the monomeric, mono-functional organic acid (c). The metal cation (d) is added in an amount sufficient to neutralize from about 65 to about 90% of the acid groups in the combination to produce a neutralized ionomer material. Suitable metal salts may include Group I alkali metal salts, Group II alkaline earth metal salts, and transition metal salts. For example, lithium, sodium, potassium, magnesium, calcium, iron, barium, lead, tin, zinc, aluminum, bismuth, chromium, cobalt, copper, strontium, titanium, tungsten, nickel, manganese, or a combination of these cations may be used. In particular examples, alkali, alkaline earth, or zinc metal cations may be used.

Nonlimiting examples of suitable sources for the metal cation that may be used in the highly resilient polymer include acetates, oxides and hydroxides of lithium, calcium, zinc, sodium, potassium, nickel, magnesium, aluminum, zirconium and manganese. Some specific, nonlimiting examples of suitable metal cation sources are lithium hydroxide monohydrate, lithium hydroxide, lithium oxide, lithium acetate, calcium hydroxide, calcium acetate, calcium oxide, zinc acetate dihydrate, zinc acetate or a blend of zinc oxide and acetic acid, sodium hydroxide, sodium acetate, potassium hydroxide, potassium acetate, nickel acetate, nickel oxide, nickel hydroxide, magnesium oxide, magnesium hydroxide, magnesium acetate, manganese acetate, and manganese oxide. These may be used in any combination.

In various embodiments of the highly resilient polymer the metal cation source is selected from zinc acetate dihydrate, zinc acetate or a blend of zinc oxide and acetic acid, magnesium oxide, magnesium hydroxide, magnesium acetate, and combinations of these.

The metal cation is included in an amount sufficient to neutralize from about 65 to about 90% of the acid groups in the combination to produce the highly resilient polymer. In various embodiments, the metal cation is included in an amount sufficient to neutralize from about 65 or about 75 to about 85 or about 90% of the acid groups of the combination, and may be included in an amount sufficient to neutralize from about 75 to about 85% of the acid groups of the copolymers (a) and (b) or of all acid groups in the highly resilient polymer.

The highly resilient polymer may be produced using conventional melt blending procedures. In an example embodiment, the copolymers, unsaturated fatty acid, and metal cation source are blended in a Banbury™ type mixer, two-roll mill, or extruder, for example a twin-screw extruder. In the melt, the hydrogens on the acid group of both the ethylene (meth)acrylic acid copolymer and the fatty acid undergo a condensation reaction with the metal cation. The combination of the copolymers, the unsaturated fatty acid, and the metal cation may be mixed at a temperature at which both of the copolymers are molten. In some example embodiments, the combination of the copolymers, the unsaturated fatty acid, and the metal cation are mixed together at a temperature from about 150° C. to about 200° C. until the desired percentage neutralization of the acid groups is complete. The blended and reacted ionomeric highly resilient polymer is then cooled.

In various embodiments, the golf ball includes from about 23 percent, or at least about 50 percent, by volume to 100 percent by volume of at least one highly resilient polymer.

In another example, a thermoplastic material includes a combination of a metal ionomer of a copolymer of ethylene and at least one of acrylic acid and methacrylic acid, a metallocene-catalyzed copolymer of ethylene and an α-olefin having 4 to about 8 carbon atoms, and a metal salt of an unsaturated fatty acid prepared as described in Statz et al., U.S. Pat. No. 7,375,151 the entire contents of which is incorporated herein by reference.

When the ball has a core and a cover, each of the core and the cover may include at least one ionomer resin. In certain example embodiments, the core includes at least one ionomer resin comprising a combination of (i) a copolymer of an alpha-olefin, from about 4 wt. % to about 35 wt. % of an ethylenically unsaturated acid, and, optionally, one or more further comonomers; (ii) an aliphatic, monomeric, mono-functional organic acid, and (iii) a sufficient amount of a metal cation to neutralize at least about 70% of the combined acid groups of (i) and (ii). In specific embodiments, the alpha-olefin is ethylene. In these or other specific embodiments, the aliphatic, monomeric, mono-functional organic acid may have from 6 to less than 36 carbon atoms, and may have from 8 to 20 carbon atoms. The metal cation may be used in a sufficient amount to neutralize for example at least about 80%, or at least about 90%, or at least about 95%, or at least about 98%, up to 100% of the combined acid groups of (i) and (ii). In each of these embodiments, the cover may include at least one ionomer resin neutralized at least about 40%, and the polymeric portion of the cover may consist essentially of the at least one ionomer resin or the polymeric portion of the core may consist essentially of the at least one ionomer resin, including embodiments in which a core and one or more intermediate layers between the core and the cover independently consists of an ionomer resin, each of which may be the same or different from another.

Other thermoplastic elastomers that may be used in making the low density golf ball include polyolefin elastomers. One type of thermoplastic polyolefin elastomers are metallocene-catalyzed block copolymers of ethylene and α-olefins having 4 to about 8 carbon atoms that are prepared by single-site metallocene catalysis, for example in a high pressure process in the presence of a catalyst system comprising a cyclopentadienyl-transition metal compound and an alumoxane. Nonlimiting examples of the α-olefin softening comonomer copolymerized with the ethylene include hexane-1 and octene-1; octene-1 is a one example comonomer. These materials are commercially available, for example, from ExxonMobil under the tradename Exact™ and from the Dow Chemical Company under the tradename Engage™.

Suitable thermoplastic styrene block copolymer elastomers that may be used in the thermoplastic materials of the golf ball include poly(styrene-butadiene-styrene), poly(styrene-ethylene-co-butylene-styrene), poly(styrene-isoprene-styrene), and poly(styrene-ethylene-co-propylene) copolymers. These styrenic block copolymers may be prepared by living anionic polymerization with sequential addition of styrene and the diene forming the soft block, for example using butyl lithium as initiator. Thermoplastic styrene block copolymer elastomers are commercially available, for example, under the trademark Kraton™ sold by Kraton Polymers U.S. LLC, Houston, Tex. Other such elastomers may be made as block copolymers by using other polymerizable, hard, non-rubber monomers in place of the styrene, including meth(acrylate) esters such as methyl methacrylate and cyclohexyl methacrylate, and other vinyl arylenes, such as alkyl styrenes.

Thermoplastic polyurethane elastomers such as thermoplastic polyester-polyurethanes, polyether-polyurethanes, and polycarbonate-polyurethanes may be used in making the golf ball, particularly used in making the cover of a two-piece or multi-piece golf ball. The thermoplastic polyurethane elastomers include polyurethanes polymerized using as polymeric diol reactants polyethers and polyesters, for example polycaprolactone polyesters. These polymeric diol-based polyurethanes are prepared by reaction of the polymeric diol (polyester diol, polyether diol, polycaprolactone diol, polytetrahydrofuran diol, or polycarbonate diol), one or more polyisocyanates, and, optionally, one or more chain extension compounds. Chain extension compounds, as the term is being used, are compounds having two or more functional groups reactive with isocyanate groups, such as the diols, amino alcohols, and diamines. The polymeric diol-based polyurethane may be substantially linear (i.e., substantially all of the reactants are difunctional).

The polyester diols used in forming a thermoplastic polyurethane elastomer are in general prepared by the condensation polymerization of one or more polyacid compounds and one or more polyol compounds. A polymeric polyether or polycaprolactone diol reactant for preparing thermoplastic polyurethane elastomers may be obtained by reacting a diol initiator, e.g., 1,3-propanediol or ethylene or propylene glycol, with a lactone or alkylene oxide chain-extension reagent. Lactones that can be ring opened by an active hydrogen are well-known in the art. In one example embodiment, the lactone is ε-caprolactone. In other embodiments, a diol initiator may be reacted with an oxirane-containing compound to produce a polyether diol to be used in the polyurethane elastomer polymerization. The oxirane-containing compound may be selected from ethylene oxide, propylene oxide, butylene oxide, tetrahydrofuran, and combinations of these. Polytetrahydrofuran, also known as polytetramethylene ether glycol (PTMEG), is one example polymeric polyol for use in making the thermoplastic polyurethane elastomer. Aliphatic polycarbonate diols that may be used in making a thermoplastic polyurethane elastomer may be prepared by the reaction of diols with dialkyl carbonates (such as diethyl carbonate), diphenyl carbonate, or dioxolanones (such as cyclic carbonates having five- and six-member rings) in the presence of catalysts like alkali metal, tin catalysts, or titanium compounds. Aromatic polycarbonates are usually prepared from reaction of bisphenols, e.g., bisphenol A, with phosgene or diphenyl carbonate.

Suitable thermoplastic polyurea elastomers may be prepared by reaction of one or more polymeric diamines or polyols with one or more of the polyisocyanates already mentioned and one or more diamine extenders. Nonlimiting examples of suitable diamine extenders include ethylene diamine, 1,3-propylene diamine, 2-methyl-pentamethylene diamine, hexamethylene diamine, 2,2,4- and 2,4,4-trimethyl-1,6-hexane diamine, imino-bis(propylamine), imido-bis(propylamine), N-(3-aminopropyl)-N-methyl-1,3-propanediamine), 1,4-bis(3-aminopropoxy)butane, diethyleneglycol-di(aminopropyl)ether), 1-methyl-2,6-diamino-cyclohexane, 1,4-diamino-cyclohexane, 1,3- or 1,4-bis(methylamino)-cyclohexane, isophorone diamine, 1,2- or 1,4-bis(sec-butylamino)-cyclohexane, N,N′-diisopropyl-isophorone diamine, 4,4′-diamino-dicyclohexylmethane, 3,3′-dimethyl-4,4′-diamino-dicyclohexylmethane, N,N′-dialkylamino-dicyclohexylmethane, and 3,3′-diethyl-5,5′-dimethyl-4,4′-diamino-dicyclohexylmethane. Polymeric diamines include polyoxyethylene diamines, polyoxypropylene diamines, poly(oxyethylene-oxypropylene) diamines, and poly(tetramethylene ether) diamines. The amine- and hydroxyl-functional extenders already mentioned may be used as well. Generally, as before, trifunctional reactants are limited and may be used in conjunction with monofunctional reactants to prevent crosslinking.

Suitable thermoplastic polyamide elastomers may be obtained by: (1) polycondensation of (a) a dicarboxylic acid, such as oxalic acid, adipic acid, sebacic acid, terephthalic acid, isophthalic acid, 1,4-cyclohexanedicarboxylic acid, or any of the other dicarboxylic acids already mentioned with (b) a diamine, such as ethylenediamine, tetramethylenediamine, pentamethylenediamine, hexamethylenediamine, or decamethylenediamine, 1,4-cyclohexanediamine, m-xylylenediamine, or any of the other diamines already mentioned; (2) a ring-opening polymerization of a cyclic lactam, such as ε-caprolactam or ω-laurolactam; (3) polycondensation of an aminocarboxylic acid, such as 6-aminocaproic acid, 9-aminononanoic acid, 11-aminoundecanoic acid, or 12-aminododecanoic acid; or (4) copolymerization of a cyclic lactam with a dicarboxylic acid and a diamine to prepare a carboxylic acid-functional polyamide block, followed by reaction with a polymeric ether diol (polyoxyalkylene glycol) such as any of those already mentioned. Polymerization may be carried out, for example, at temperatures of from about 180° C. to about 300° C. Specific examples of suitable polyamide block copolymers include NYLON 6, NYLON 66, NYLON 610, NYLON 11, NYLON 12, copolymerized NYLON MXD6, and NYLON 46 based elastomers. Thermoplastic poly(ether amide) block copolymer elastomers (PEBA) are commercially available under the trademark Pebax® from Arkema.

Thermoplastic polyester elastomers have blocks of monomer units with low chain length that form the crystalline regions and blocks of softening segments with monomer units having relatively higher chain lengths. Thermoplastic polyester elastomers are commercially available under the trademark Hytrel® from DuPont.

In another example, the disclosed golf ball is made with a core or intermediate layer including an uncrosslinked, thermoplastic ethylene propylene diene monomer copolymer (EPDM). The thermoplastic EPDM may have an ethylene content of from about 40 wt. % to about 70 wt. %, for example an ethylene content of from about 45 wt. % to about 65 wt. % or an ethylene content of from about 45 wt. % to about 60 wt. %. The thermoplastic EPDM may have a specific gravity of from about 0.85 to about 0.9 or from about 0.85 to about 0.88. Such thermoplastic EPDM grades are available from the Dow Chemical Company under the trademark NORDEL™′

In another example, the disclosed golf ball is made with a core or intermediate layer of a dynamic vulcanizate of EPDM in a thermoplastic matrix of one or more of the non-rubber thermoplastic materials described above. In specific examples, the core or intermediate layer may be a dynamic vulcanizate of EPDM in one or more of ionomer resins, highly neutralized polymers, highly resilient polymers, metallocene-catalyzed block copolymers of ethylene and α-olefins having 4 to about 8 carbon atoms, thermoplastic polyamide elastomers, thermoplastic polyester elastomers, thermoplastic styrene block copolymer elastomers, thermoplastic polyurethane elastomers, and thermoplastic polyurea elastomers. In various embodiments the disclosed golf ball is made with a core or intermediate layer of a dynamic vulcanizate of EPDM in a highly neutralized polymer, such as any of those described above, or in a highly resilient polymer, such as any of those described above.

In various embodiments, the golf ball has a core and a cover, and the density of the golf ball without the cover is up to about 0.95 g/cm³. In various embodiments, the golf ball may have a one-piece core or may have a core and one or more intermediate layers between the core and the cover. The core, at least one intermediate layer, or both may be made with a combination of an ionomer resin, especially a highly neutralized ionomer resin, and a thermoplastic polyolefin elastomer, with the polyolefin elastomer being be up to about 50 weight percent, for example from about 5 wt % or from about 10 wt % up to about 40 wt % of the combination. The thermoplastic materials of the golf ball core and cover may include combinations of thermoplastic elastomers.

The golf ball or one of its components, if a multi-piece golf ball, may include one or more fillers, such as a lightweight filler. Nonlimiting examples of light-weight fillers that may be used to decrease density include particulate plastics, glass, ceramics, foamed particles, and hollow spheres. Any filler is used in an amount that does not appreciably decrease the reliance of the golf ball as compared to an unfilled golf ball. Filler is including in an amount of for example up to about 10 weight percent, or up to about 3 weight percent, or up to about 2 weight percent, or zero weight percent, based on the total golf ball weight, especially when the core or an intermediate layer of the golf ball is made using a highly neutralized polymer.

In certain example embodiments, the golf ball core and any intermediate layer or layers are solid, that is, not foamed or hollow. In other embodiments, the golf ball may include a hollow core or a foamed or foam-containing core or intermediate layer. Customary additives can also be included in the golf ball, for example dispersants, antioxidants such as phenols, phosphites, and hydrazides, processing aids, surfactants, stabilizers, and so on.

When the golf ball has a cover, the cover may be formulated with a pigment, such as a yellow or white pigment, and in particular a white pigment such as titanium dioxide or zinc oxide. Generally titanium dioxide is used as a white pigment, for example in amounts of from about 0.5 parts by weight or 1 part by weight to about 8 parts by weight or 10 parts by weight passed on 100 parts by weight of polymer. In various embodiments, a white-colored cover may be tinted with a small amount of blue pigment or brightener. The cover may also contain additives such as hindered amine light stabilizers such as piperidines and oxanalides, ultraviolet light absorbers such as benzotriazoles, triazines, and hindered phenols, fluorescent materials and fluorescent brighteners, dyes such as blue dye, and antistatic agents.

The golf ball and (if multi-layer) its component parts may be made by conventional methods, such as by injection molding, compression molding, casting, and other known methods. The golf ball typically has a surface dimple pattern and profile to provide desirable aerodynamic characteristics to the golf ball.

After a golf ball has been molded, it may undergo various further conventional processing steps such as buffing, painting and marking. In one example, the golf ball has a dimple pattern that coverage of 65% or more of the surface. The golf ball typically is coated with a durable, abrasion-resistant and relatively non-yellowing finish coat.

The following examples illustrate, but do not in any way limit, the scope of the methods and compositions as described and claimed. All parts are parts by weight unless otherwise noted.

### EXAMPLES

### Example 1

A golf ball is made by molding a core of DuPont™ HPF 2000 (obtained from E.I du Pont de Nemours and Company, Inc.), then applying a 1.7 mm-thick cover of a 50:50 by weight blend of Surlyn® 8940 and Surlyn® 9910 (obtained from E.I du Pont de Nemours and Company, Inc.). The assembled ball has a diameter of 45.1 mm and a weight of 45.6 g. Its density, determined by dividing the weight by a volume calculated from its radius, is 0.95 g/cm³.

### Comparative Example A

A golf ball is made by molding a core from a polybutadiene compounded with crosslinker and peroxide, then applying a 1.7 mm-thick cover of a 50:50 by weight blend of Surlyn® 8940 and Surlyn® 9910 (obtained from E.I du Pont de Nemours and Company, Inc.). The assembled ball has a diameter of 42.9 mm and a weight of 44.8 g. Its density, determined by dividing the weight by a volume calculated from its radius, is 1.08 g/cm³.

### Comparative Example B

A golf ball is made by molding a core from a polybutadiene compounded with crosslinker and peroxide, then applying a 1.7 mm-thick cover of a 50:50 by weight blend of Surlyn® 8940 and Surlyn® 9910 (obtained from E.I du Pont de Nemours and Company, Inc.) pigmented with rutile titanium dioxide. The assembled ball has a diameter of 45.1 mm and a weight of 52.3 g. Its density, determined by dividing the weight by a volume calculated from its radius, is 1.09 g/cm³.

### Comparative Example C

A commercial ball, Topflite Magna, was obtained and measured. The Magna ball had a 2.0 mm-thick cover, weighted 45.8 g, and had a ball diameter of 43.6. Its calculated density is 1.06 g/cm³.

In the following table, each of the Example 1 and Comparative Examples A-C are compared for height, from the ground, of the ball's “sweet spot” for iron shots.

| Golf ball | | Comparative | Comparative | Comparative |
|---|---|---|---|---|
| measurements | Example 1 | Example A | Example B | Example C¹ |
| Weight, g | 45.6 | 44.8 | 52.2 | 45.8 |
| Diameter, mm | 45.1 | 42.9 | 45.1 | 43.6 |
| Density, g/cm³ | 0.95 | 1.08 | 1.09 | 1.06 |
| Iron sweet | 22.6 | 21.5 | 22.6 | 21.8 |
| spot height, | | | | |
| mm | | | | |
| Cover | 1.7 mm | 1.7 mm | 1.7 mm | 2.0 mm |
| (Surlyn ®² | | | | |
| ionomer) | | | | |

¹Comparative Example C is a TOP-FLITE Magna 2-piece golf ball. The cover is believed to be a Surlyn ®²-type ionomer resin material.
²Surlyn ® is a registered trademark of E. I. du Pont de Nemours and Company.

The description is merely exemplary in nature and, thus, variations that do not depart from the gist of the disclosure are a part of the disclosed technology. In the claims that follow, “any of” is understood to include any possible combination of the recited feature or features of the dependent claim with any of the foregoing claims to which reference is made, including combinations with any one of the foregoing claims to which reference is made.

What is claimed is:

1. A golf ball, wherein the golf ball has a diameter of about 43.18 mm up to about 46 mm and a density of about 0.85 g/cm³ to 1.05 g/cm³.

2. A golf ball according to claim 1, wherein the golf ball weighs up to 45.926 grams.

3. A golf ball according to claim 2, wherein the golf ball has a diameter of about 43.6 mm to about 46 mm.

4. A golf ball according to claim 1, wherein the golf ball has a density of from about 0.85 g/cm³ to about 1.00 g/cm³.

5. A golf ball according to claim 1, comprising from about 23 percent by volume to 100 percent by volume of at least one ionomer resin neutralized from about 40% to 100%.

6. A golf ball according to claim 1, wherein the golf ball comprises a cover and a core, wherein the core comprises a combination of
(i) a copolymer of an alpha olefin, from about 4 wt. % to about 35 wt. % of an ethylenically unsaturated acid, and, optionally, a softening monomer;
(ii) an aliphatic, monomeric, mono-functional organic acid, and
(iii) a sufficient amount of a metal cation to neutralize from about 80% to 100% of the combined acid groups of (i) and (ii).

7. A golf ball according to claim 6, wherein the alpha olefin is ethylene.

8. A golf ball according to claim 6, wherein the component (ii) has from about 6 to about 36 carbon atoms.

9. A golf ball according to claim 6, wherein metal cation (iii) neutralizes from about 95% to 100% of the combined acid groups of (i) and (ii).

10. A golf ball according to claim 6, wherein the cover comprises at least one ionomer resin neutralized from about 40% to 100%.

11. A golf ball according to claim 10, wherein the polymeric portion of the cover consists essentially of the at least one ionomer resin.

12. A golf ball according to claim 10, wherein the total amount of ionomer resin is from about 50 percent by volume to 100% of the polymeric portion of the golf ball.

13. A golf ball according to claim 10, wherein the polymeric portion of the golf ball consists essentially of ionomer resin.

14. A golf ball according to claim 1, wherein the golf ball has a cover and a thermoplastic core.

15. A golf ball according to claim 1, wherein the golf ball has a solid core.

16. A golf ball according to claim 1 that conforms to the USGA IV test (not more than 255 feet per second).

17. A golf ball according to claim 1, wherein the golf ball is solid.

18. A golf ball according to claim 1, wherein the golf ball is free of any filler.

19. A golf ball, comprising a layer of a foamed composition comprising:
(i) a copolymer of an alpha olefin, from about 4 wt. % to about 35 wt. % of an ethylenically unsaturated acid, and, optionally, a softening monomer;
(ii) an aliphatic, monomeric, mono-functional organic acid, and
(iii) a sufficient amount of a metal cation to neutralize from about 70% to 100% of the combined acid groups of (i) and (ii),
wherein the golf ball has a diameter of at least about 43.18 mm and a density of from about 0.85 g/cm³ to about 1.05 g/cm³.

20. A golf ball according to claim 19, wherein the golf ball has a diameter 43.18 mm to about 46.3 mm and conforms to USGA rules.

21. A golf ball according to claim 19, wherein the combination further comprises a metallocene-catalyzed block copolymer of ethylene and an α-olefin having 4 to about 8 carbon atoms.

22. A method of making a golf ball, comprising
forming a core;
optionally, surrounding the core with one or more intermediate layers, and
forming a cover as an outermost layer,
wherein the golf ball has a diameter of about 43.6 mm up to about 46 mm and a density of from about 0.85 g/cm³ to 1.05 g/cm³.

23. A method according to claim 22, wherein the core consists essentially of a member selected from the group consisting of (i) copolymers of an alpha olefin, from about 4 wt. % to about 35 wt. % of an ethylenically unsaturated acid, and, optionally, a softening monomer neutralized at least about 40%, (ii) highly neutralized polymers, (iii) highly resilient polymers, (iv) combinations of (i)-(iii), (v) combinations of (i)-(iii) with uncrosslinked EPDM, and (vi) dynamically vulcanized EPDM in (i)-(iv).

24. A method according to claim 22, comprising surrounding the core with an intermediate layer consisting essentially of a member selected from the group consisting of (i) copolymers of an alpha olefin, from about 4 wt. % to about 35 wt. % of an ethylenically unsaturated acid, and, optionally, a softening monomer neutralized at least about 40%, (ii) highly neutralized polymers, (iii) highly resilient polymers, (iv) combinations of (i)-(iii), (v) combinations of (i)-(iii) with uncrosslinked EPDM, and (vi) dynamically vulcanized EPDM in (i)-(iv).

25. A method according to claim 23, wherein the member is foamed.

26. A method according to claim 22, wherein the cover is formed ionomer resin.
